(19) United States
(12) Patent Application Publication
(10) Pub. No.: US 2012/0164504 A1
(43) Pub. Date: Jun. 28, 2012

(54) POWER SOURCE APPARATUS, DUST-FREE CASE, AND VEHICLE EQUIPPED WITH THE POWER SOURCE APPARATUS

(76) Inventors: Tomokazu TAKASHINA, Kobe-shi (JP); Jun Masuda, Himeji-shi (JP)

(21) Appl. No.: 13/336,372

(22) Filed: Dec. 23, 2011

(30) Foreign Application Priority Data
Dec. 27, 2010 (JP) 2010-291365

(51) Int. Cl. H01M 2/10

(52) U.S. Cl. 429/99; 429/100

(57) ABSTRACT

The power source apparatus has sealing material 15 with flexible projections 44 extending in the lengthwise direction and intervening between cover-attachment-surfaces 4a on a base-plate 4 and base-attachment-surfaces 8a on a cover-plate 5. Ends of the cover-plate 5 are provided with hood segments 8b that extend from the base-attachment-surfaces 8a in a direction approximately perpendicular to the attachment-surfaces and cover the sides of the sealing material 15 and cover-attachment-surfaces 4a. In addition, sealing pieces 16 are provided between the cover-plate 5 and the sealing material 15 in a manner that extends continuously from the base-attachment-surface 8a to the hood segment 8b. With sealing material 15 intervening between cover-attachment-surfaces 4a and base-attachment-surfaces 8a, base-plate 4 and cover-plate 5 attachment-surfaces are sealed together with the sealing pieces 16 compressed on top of the flexible projections 44.

### BACKGROUND OF THE INVENTION

1. Field of the Invention

The present invention relates to a high-current power source apparatus used primarily as the power source for a motor that drives a vehicle such as a hybrid or electric vehicle, or used in home or industrial power storage applications etc., and to a dust-free case and vehicle equipped with the power source apparatus.

2. Description of the Related Art

An electric vehicle (EV, electric automobile, electric car) driven by an electric motor and a hybrid vehicle (HV, hybrid electric vehicle, HEV, hybrid car) driven by both an electric motor and an engine carry on-board a power source apparatus with a plurality of battery cells housed in a case. Since high output power is necessary to enable an electric motor to drive a vehicle, the power source apparatus has numerous battery cells connected in series to increase the output voltage. For example, although most automotive electrical system batteries installed on-board vehicles are 12V, the output-voltage of a power source apparatus that powers a driving motor is extremely high and typically greater than or equal to 200V.

The case that houses the battery cells of the power source apparatus has a dust-resistant and water-resistant structure to protect the battery cells. This is necessary because the ingress of dust, dirt, and water into the case can cause contact resistance or malfunction of electrical components inside the case. In particular, gaps can easily form at the connecting regions between pieces of the case. Accordingly, a sealed structure has been proposed that can reliably seal the gaps in the battery case.

Refer to Japanese Laid-Open Patent Publication 2010-153128.

A cross-section view of this prior art battery case is shown in FIG. 20. The battery case in this figure is configured with a tray piece 51 sealed closed by a cover piece 52. A sealing groove 56 is formed in the attachment-surface 55 of the tray piece 51, and sealing material 57 is disposed in that sealing groove 56. The sealing groove 56 and sealing material 57 are established continuously around the perimeter side-walls 54 of the tray piece. First buried nuts 62 are disposed in inserted metal pieces 61. The tray piece 51 and cover piece 52 are fastened together with intervening sealing material 57 by placing the flange 58 of the cover piece 52 on the tray piece 51 attachment-surface 55 and screwing bolts 60 into the buried nuts 62. With this structure, the connecting region of the tray piece 51 and cover piece 52 can be reliably sealed closed by the sealing material 57, and the dust-resistance of the battery case can be improved.

By extension of continuous sealing material, the structure described above can seal the connecting surface between the tray piece and cover piece. However, in places where the sealing material cannot be disposed, the sealing potential of this structure cannot be realized. For example, a problem occurs in the battery case structure shown in the oblique views of FIGS. 21 and 22 where there is not only a cover piece 63 and a tray piece 65, but also separate side-plates 66. As shown in FIG. 23, a small gap GP develops between a side-plate 66 and the sealing material 64. Here, even if the sealing material 64 is extended into the gap region, complete sealing material 64 coverage of the corner region gap is problematic due to considerations such as manufacturing tolerances. In this type of situation, complete prevention of dust, dirt, and water ingress through the gap region is not possible. For example, there is demand for a vehicle power source apparatus that can prevent ingress of particulates less than or equal to ·75 μm, and prior art structures have been unable to sufficiently respond to this demand.

The present invention was developed with the object of resolving these types of prior art problems. Thus, it is a primary object of the present invention to provide a power source apparatus, dust-free case, and vehicle equipped with the power source apparatus that can reliably seal attachment-surface gaps in the case connecting regions.

### SUMMARY OF THE INVENTION

To realize the object cited above, the power source apparatus for the first aspect of the present invention is provided with battery blocks 2 having a plurality of battery cells 1 connected together, a base-plate 4 that holds the battery blocks 2 and has cover-attachment-surfaces 4a established on perimeter edges, a cover-plate 5 that closes-off the top of the base-plate 4 and has base-attachment-surfaces 8a, 7a, 5a′ established on perimeter edges that join with base-plate 4 cover-attachment-surfaces 4a, and sealing material 15 that intervenes between base-plate 4 cover-attachment-surfaces 4a and cover-plate 5 base-attachment-surfaces 8a, 7a, 5a′ and has flexible projections 44 extending in the lengthwise direction. Ends of the cover-plate 5 are provided with hood segments 8b that extend from the base-attachment-surfaces 8a, 7a, 5a′ in a direction approximately perpendicular to the attachment-surfaces and cover the sides of the sealing material 15 and cover-attachment-surfaces 4a. In addition, sealing pieces 16 are provided between the cover-plate 5 and the sealing material 15 in a manner that extends continuously from the base-attachment-surface 8a, 7a, 5a′ to the hood segment 8b. With sealing material 15 intervening between cover-attachment-surfaces 4a and base-attachment-surfaces 8a, 7a, 5a′, base-plate 4 and cover-plate 5 attachment-surfaces are sealed together with the sealing pieces 16 compressed on top of the flexible projections 44. As a result, attachment-surfaces with sealing pieces extending from the base-attachment-surfaces to the backsides of the hood segments are pressed together from an approximately perpendicular direction allowing a dust-free configuration to be achieved.

In the power source apparatus for the second aspect of the present invention, side-plates 6 are provided that close-off open ends of the cover-plate 5 and base-plate 4, gaps are formed at the boundaries between the side-plates 6 and the ends of the attachment-surfaces, and the hood segments 8b and sealing pieces 16 are established in the gap regions. As a result, even if factors such as manufacturing tolerances cause gaps to be formed at the boundaries between the side-plates and attachment-surfaces, the gaps can be reliably sealed closed via the sealing pieces to achieve the positive feature of a dust-free structure.

In the power source apparatus for the third aspect of the present invention, the hood segments 8b can extend in the lengthwise direction of the base-plate 4 to cover boundaries between the base-plate 4 and side-plates 6. As a result, boundaries between the base-plate and side-plates are covered by the cover-plate burying the gaps beneath the backsides of the hood segments, and a dust-free structure can be achieved.

In the power source apparatus for the forth aspect of the present invention, the sealing pieces 16 can be adhesively attached to the undersides of the cover-plate 5. This makes sealing piece alignment unnecessary and achieves the positive feature of minimizing labor intensive assembly operations.

In the power source apparatus for the fifth aspect of the present invention, the sealing material 15 can be configured as a flat-plate rigid piece and a flat-plate flexible piece that interlocks with the rigid piece. As a result, deterioration over time, which occurs with the use of materials such as rubber gaskets, can be prevented to allow stable long-term use. In particular, even in a harsh environment with vibration and impact such as in a power source apparatus on-board a vehicle, a dust-free structure can be maintained with high reliability. Further, even in environments exposed to blowing rain and snow such as in a power source apparatus installed outdoors for street lighting, long-term operation can be achieved.

In the power source apparatus for the sixth aspect of the present invention, the boundary between the rigid piece and the flexible piece can be formed with segments that are not in a straight-line, and the flexible projections 44 can be established on the flexible piece following the meandering boundary.

The vehicle for the eighth aspect of the present invention can be equipped with any of the power source apparatus described above.

The dust-free case for the eighth aspect of the present invention is provided with a base-plate 4 that has cover-attachment-surfaces 4a established on perimeter edges, a cover-plate 5 that closes-off the top of the base-plate 4 and has base-attachment-surfaces 8a, 7a, 5a′ established on perimeter edges that join with base-plate 4 cover-attachment-surfaces 4a, and sealing material 15 that intervenes between base-plate 4 cover-attachment-surfaces 4a and cover-plate 5 base-attachment-surfaces 8a, 7a, 5a′ and has flexible projections 44 extending in the lengthwise direction. Ends of the cover-plate 5 are provided with hood segments 8b that extend from the base-attachment-surfaces 8a, 7a, 5a′ in a direction approximately perpendicular to the attachment-surfaces and cover the sides of the sealing material 15 and cover-attachment-surfaces 4a. In addition, sealing pieces 16 are provided between the cover-plate 5 and the sealing material 15 in a manner that extends continuously from the base-attachment-surface 8a, 7a, 5a′ to the hood segment 8b. With sealing material 15 intervening between cover-attachment-surfaces 4a and base-attachment-surfaces 8a, 7a, 5a′, base-plate 4 and cover-plate 5 attachment-surfaces can be sealed together with the sealing pieces 16 compressed on top of the flexible projections 44. As a result, attachment-surfaces with sealing pieces extending from the base-attachment-surfaces to the backsides of the hood segments are pressed together from an approximately perpendicular direction allowing a dust-free configuration to be achieved. The above and further objects of the present invention as well as the features thereof will become more apparent from the following detailed description to be made in conjunction with the accompanying drawings.

### BRIEF DESCRIPTION OF THE DRAWINGS

FIG. 1 is an oblique view showing a power source apparatus for the first embodiment;

FIG. 2 is an exploded oblique view showing the electrical component cover removed from the power source apparatus in FIG. 1;

FIG. 3 is an oblique view from below of the power source apparatus in FIG. 2;

FIG. 4 is an exploded oblique view showing the power source apparatus in FIG. 2 with side-plates also removed;

FIG. 5 is an oblique view showing the battery blocks of the power source apparatus in FIG. 4;

FIG. 6 is a cross-section view through the line VI-VI on the power source apparatus in FIG. 1;

FIG. 7 is a cross-section view through the line VII-VII on the power source apparatus in FIG. 1;

FIG. 8 is an enlarged cross-section view through the line VIII-VIII in FIG. 1;

FIG. 9 is an enlarged cross-section view through the line IX-IX in FIG. 1;

FIG. 10 is an oblique view showing the outline of the sealing material;

FIG. 11 is an exploded oblique view of the sealing material in FIG. 10;

FIG. 12 is an oblique view in cross-section showing the connecting region of a cover-attachment-surface with a base-attachment-surface;

FIG. 13 is an enlarged exploded oblique view showing the gap region;

FIG. 14 is an enlarged oblique view showing the cover-plate joined to the base-plate in FIG. 13;

FIG. 15 is an exploded oblique view from below and behind the gap region shown in FIG. 13;

FIG. 16 is an oblique view showing a power source apparatus for the second embodiment;

FIG. 17 is a block diagram showing an example of a hybrid vehicle, which is driven by a motor and an engine, equipped with a power source apparatus;

FIG. 18 is a block diagram showing an example of an electric vehicle, which is driven by a motor only, equipped with a power source apparatus;

FIG. 19 is a block diagram showing an example of a power source apparatus used in a power storage application;

FIG. 20 is a cross-section view showing a prior art battery case;

FIG. 21 is an oblique view showing the external appearance of a power source apparatus previously developed by the present applicant;

FIG. 22 is an exploded oblique view of the case in FIG. 21; and

FIG. 23 is an enlarged plan view with the cover in FIG. 21 removed showing the gap formed between the side-plate and the attachment-surface.

### DETAILED DESCRIPTION OF THE EMBODIMENTS

The following describes embodiments of the present invention based on the figures. However, the following embodiments are merely specific examples of a power source apparatus and vehicle equipped with the power source apparatus representative of the technology associated with the present invention, and the power source apparatus, dust-free case, and vehicle equipped with the power source apparatus of the present invention is not limited to the embodiments described below. Further, components cited in the claims are in no way limited to the components in the embodiment. In particular, in the absence of specific annotation, structural component features described in the embodiment such as dimensions, raw material, shape, and relative position are simply for the purpose of explicative example and are in no way intended to limit the scope of the invention. Properties such as the size and spatial relation of components shown in the figures may be exaggerated for the purpose of clear explanation. In the descriptions following, components with the same name and label indicate components that are the same or have the same properties and their detailed description is appropriately abbreviated. Further, a single component can serve multiple functions and a plurality of structural elements of the invention can be implemented with the same component. In contrast, the functions of a single component can be divided among a plurality of components. In addition, explanations used to describe part of one embodiment can be used in other embodiments and descriptions.

### First Embodiment

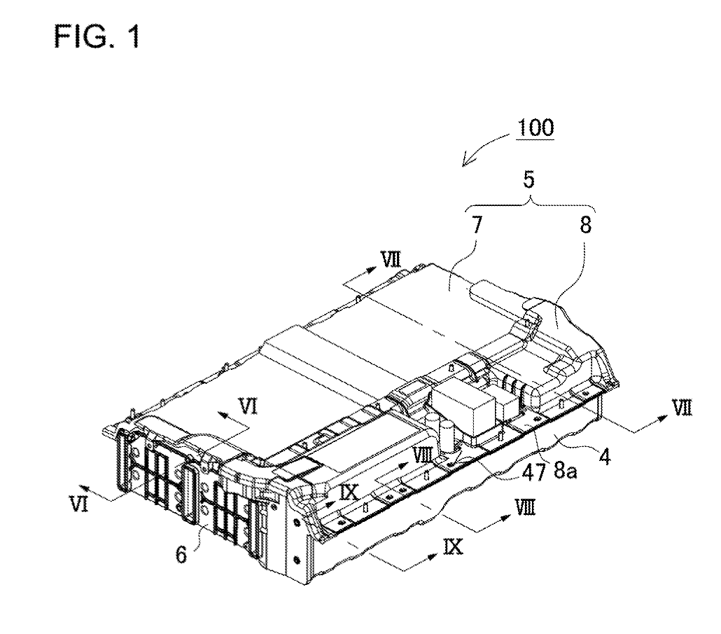

An example of a power source apparatus used on-board a vehicle is described as the first embodiment based on FIGS. 1-15. The power source apparatus shown in these figures is most suitable for use as the power source in an electric powered vehicle such as a hybrid vehicle driven by both an engine and an electric motor or an electric vehicle driven by an electric motor only. However, the power source apparatus of the present invention can also be used in vehicles other than hybrid or electric vehicles, and can also be used in applications that require high power output other than electric powered vehicles. In addition, the case can be suitably used in applications other than a power source apparatus to house electrical components that implement equipment such as a controlling device with a casing that is mechanically robust, has a dust-free structure to protect internal components from dust and dirt, and has a water-proof structure to protect internal components from moisture ingress.

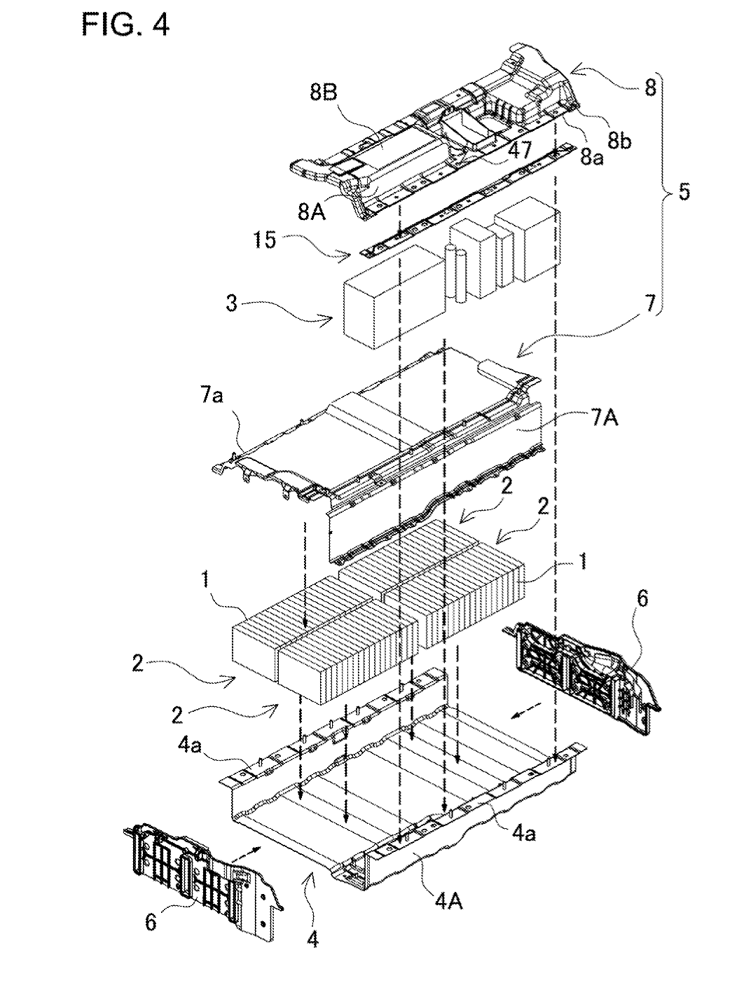

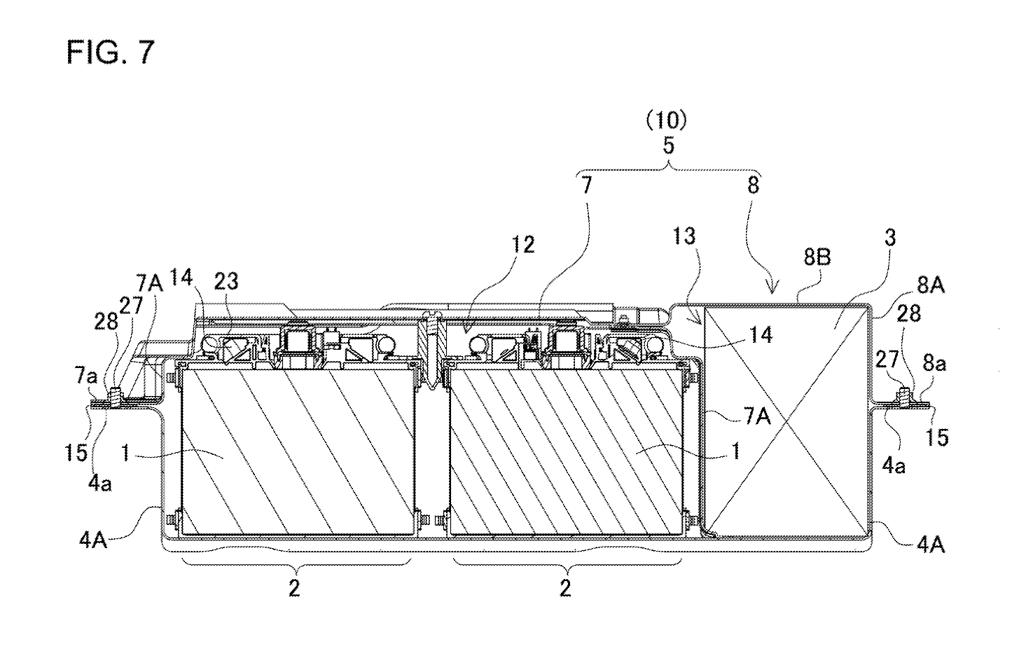

The vehicle power source apparatus 100 shown in FIGS. 1-4 is provided with battery blocks 2 having a plurality of battery cells 1 connected together, a battery state detection section 3 connected to the battery blocks 2, a base-plate 4 on which the battery blocks 2 and battery state detection section 3 are mounted, a cover-plate 5 that closes-off the top of the base-plate 4, and side-plates 6 that close-off open regions at the ends of the cover-plate 5 and base-plate 4. As shown in FIG. 7, closing-off the base-plate 4 with the cover-plate 5 establishes a battery compartment 12 that houses the battery blocks 2 and an electrical component compartment 13 that houses the battery state detection section 3. Further, the cover-plate 5 shown in FIG. 4 is made up of a top cover 7 with the battery compartment 12 inside and an electrical component cover 8 with the electrical component compartment 13 inside.

### (Battery Blocks 2)

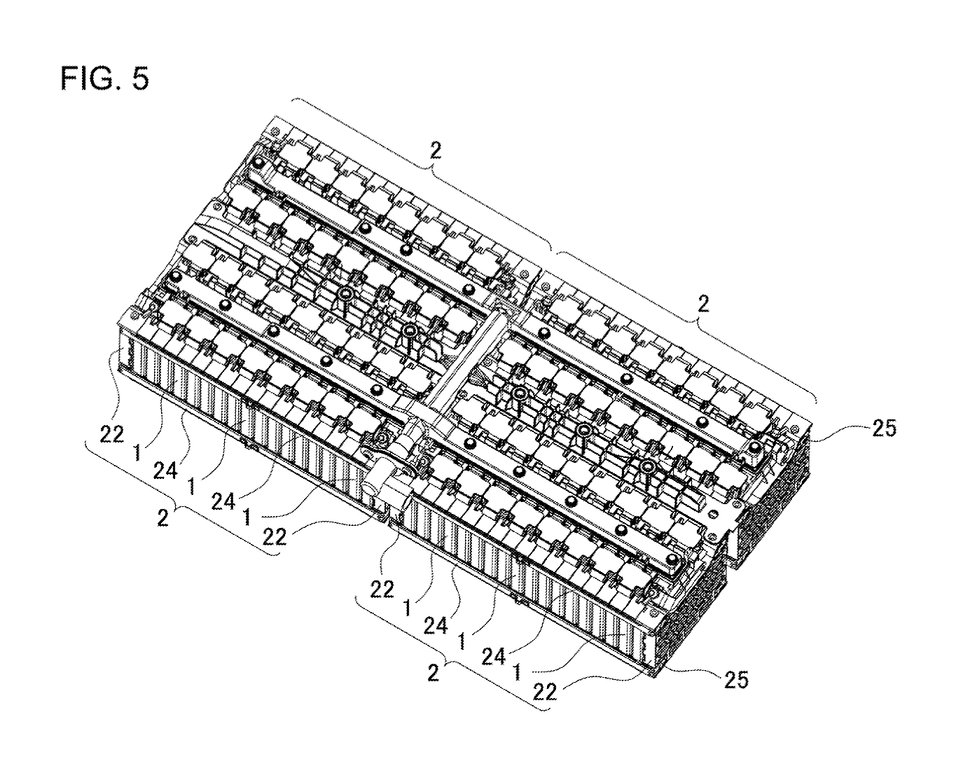

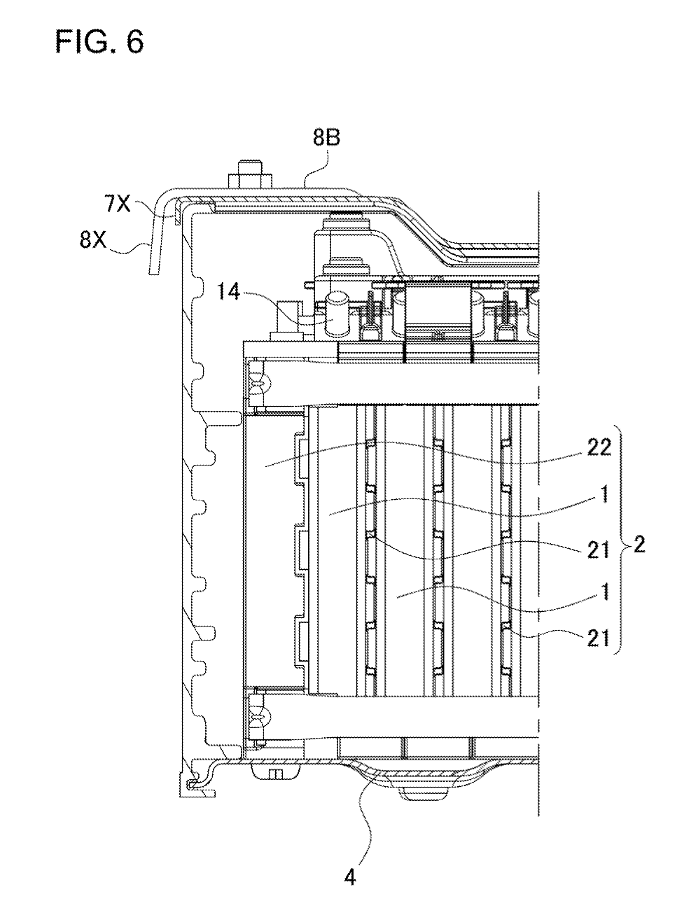

As shown in FIGS. 5 and 6, each battery block 2 has a plurality of battery cells 1 stacked together with intervening separators 21 and sandwiched between endplates 22 at each end of the stack. In a battery block 2, the plurality of battery cells 1 are disposed next to each other and adjacent battery cell 1 electrode terminals 14 are connected together. The electrode terminals 14 of adjacent battery cells 1 are electrically connected via bus-bars (not illustrated).

Each battery cell 1 is a rectangular battery. A rectangular battery has a rectangular external case with the open end hermetically sealed closed by a sealing plate. Rectangular batteries can be more efficiently arranged than circular cylindrical batteries allowing a higher energy density per unit volume to be achieved. This is particularly desirable for automotive applications where there is high demand for space reduction. Rectangular lithium ion rechargeable batteries can be used as the battery cells 1. In addition, other rechargeable batteries such as nickel-based batteries can also be used. Battery electrode terminals 14 are connected in series and/or parallel.

A battery cell 1 has a closed-bottom external case that is metal such as aluminum and the top of the external case is sealed closed with a sealing plate that is also metal such as aluminum. The sealing plate of the rectangular battery is laser-welded around the perimeter to attach the sealing plate to the open end of the external case in an airtight manner. Positive and negative electrode terminals 14 are mounted at the end regions of the sealing plate, and the electrode terminals 14 of adjacent battery cells 1 are connected to connect the batteries in series. As shown in FIG. 7, electrode terminals 14 are covered by terminal covers 23.

As shown in FIGS. 5 and 6, each battery block 2 has separators 21 sandwiched between adjacent battery cells 1. Each separator 21 has a rectangular shape approximately the same size as the outline of a battery cell 1, and is sandwiched between adjacent battery cells 1 to insulate the battery cells 1. A separator 21 is made of insulating material with superior heat resistance and thermal insulating properties, and preferably is formed from light-weight inexpensive plastic resin. For example, synthetic resins with low thermal conductivity (preferably less than or equal to 0.5 W/m) such as polypropylene or polyurethane can be used. This type of separator 21 not only mechanically protects the battery cells 1, but also provides electrical and thermal insulation between adjacent battery cells 1. In addition, a separator 21 has a corrugated shape with plateaus and grooves, and coolant is passed through the grooves to cool the battery cells 1 from the sides.

A battery block 2 has battery cells 1 and separators 21 stacked alternately and held together between a pair of endplates 22 at the ends of the stack. The endplates 22 can be made entirely of plastic, can have metal inserts in plastic, or can be a metal such as aluminum. The endplates 22 in FIG. 5 have an outline shape that is the same as a battery cell 1, and are formed with a size that can cover the battery cells 1 exposed at the ends of the battery stack. A pair of endplates 22 is connected together by fastening material 24 to hold the battery cells 1 and separators 21 stacked in between. An upper and lower pair of screw-holes (not illustrated) is provided on both sides of the endplates 22 to attach the fastening material 24. Set-screws 25, which pass through through-holes in the ends of the fastening material 24, screw into the screw-holes to hold the pair of endplates 22 together and form a battery block 2.

### (Battery State Detection Section 3)

The battery state detection section 3 is connected to the battery cells 1 and measures battery cell 1 parameters such as voltage, current, and remaining capacity to control battery cell 1 charging and discharging. The battery state detection section 3 detects battery cell 1 voltage during charging, and limits or cuts-off charging current to prevent over-charging if battery cell 1 voltage exceeds a maximum voltage. Similarly during discharging, the battery state detection section 3 limits or cuts-off discharging current to prevent over-discharging if battery cell 1 voltage drops below a minimum voltage. Further, if battery cell 1 remaining capacity exceeds a preset maximum capacity, the battery state detection section 3 limits or cuts-off charging current, and if the battery cell 1 remaining capacity drops below a minimum capacity, the battery state detection section 3 limits or cuts-off discharging current to protect the battery cells 1 from over-charging and over-discharging. In addition, the battery state detection section 3 detects battery cell 1 temperature. If battery cell 1 temperature exceeds a preset maximum temperature or drops below a preset minimum temperature, the battery state detection section 3 limits or cuts-off charging and discharging current to protect the battery cells 1. The battery state detection section 3 also detects battery cell 1 current and cuts-off excessive current flow to protect the battery cells 1. The battery state detection section 3 is implemented by electrical components mounted on circuit boards to detect the state of the battery cells 1 and control battery cell 1 charging and discharging.

### (Base-Plate 4, Cover-Plate 5, and Side-Plates 6)

The power source apparatus 100 of FIGS. 1-4 has a cover-plate 5 attached to a base-plate 4 to form an outer case 10 and establish a battery compartment 12 that houses the battery blocks 2 and an electrical component compartment 13 that houses battery state detection section 3 electrical components. The cover-plate 5 is made up of a top cover 7 and an electrical component cover 8. The outer case 10 has a battery compartment 12 established inside the base-plate 4 and the top cover 7, and has an electrical component compartment 13 established inside the base-plate 4 and the electrical component cover 8. In addition, the outer case 10 has side-plates 6 that close-off open regions at both ends of the base-plate 4 and cover-plate 5 to form the battery compartment 12 and electrical component compartment 13 inside a dust-free structure.

As shown in FIG. 6, the edges at both ends of the top cover 7 and electrical component cover 8 of the cover-plate 5 are provided with edge covers 7X, 8X that extend outward over the tops and down along the outer surfaces of the side-plates 6. These edge covers 7X, 8X establish a dust-free structure between the top cover 7 and electrical component cover 8 of the cover-plate 5 and the side-plates 6. In particular, water that drops on top of the cover-plate 5 is directed down the outsides of the side-plates 6 by the edge covers 7X, 8X to prevent water ingress into the outer case 10.

The base-plate 4, top cover 7, and electrical component cover 8 are metal plates that are strong enough to carry the weight of the battery blocks 2. The base-plate 4 and top cover 7 are made by press-forming metal plate. The base-plate 4 and top cover 7 are steel or other iron alloy that is metal-plated or coated. However, the base-plate 4 and top cover 7 can also be any metal plate such as aluminum or aluminum alloy. The base-plate 4 and top cover 7 are made from metal plate with the same thickness or the base-plate 4 is made from metal plate that is thicker than that of the top cover 7. The electrical component cover 8 is made from die-cast aluminum. Because die-cast aluminum can be made in a complex shape, it can be formed in an optimal shape for use as the electrical component cover 8. Further, as a result of superior thermal emission characteristics, aluminum can efficiently dissipate heat from internal electrical components in the battery state detection section 3. However, it is also possible to make the electrical component cover by press-forming metal plate including steel, iron alloy, aluminum, or aluminum alloy metal plate.

The base-plate 4 and top cover 7 are metal plates press-formed in U-shapes, and the electrical component cover 8 is metal formed in an L-shape. The base-plate 4 and top cover 7 have side-walls 4A, 7A provided on both sides, and the electrical component cover 8 has a side-wall 8A provided on one side. In the power source apparatus 100 of FIG. 7, the lateral width of the base-plate 4 is greater than that of the top cover 7, the electrical component compartment 13 that houses the battery state detection section 3 is established between a base-plate 4 side-wall 4A and a top cover 7 side-wall 7A, and the top of that compartment is closed-off by the electrical component cover 8. The base-plate 7 lateral width is greater than the top cover 7 lateral width by an amount equivalent to the width of the electrical component compartment 13. Said differently, the lateral width of the base-plate 4 is equal to the lateral width of the top cover 7 plus the lateral width of the electrical component compartment 13.

(Cover-Attachment-Surfaces 4a)

As shown in FIG. 7, the side-wall 4A on the left side of the base-plate 4 is attached to the side-wall 7A on the left side of the top cover 7. The side-wall 7A on the right side of the top cover 7 is attached to the bottom of the base-plate 4, and divides the electrical component compartment 13 from the battery compartment 12 housing the battery blocks 2. The top cover 7 side-wall 7A on the right side is made taller than the side-wall 7A on the left side to enable attachment of its lower edge to the bottom of the base-plate 4. Attachment-surfaces are established on perimeter edges of the base-plate 4 and top cover 7. Accordingly, the base-plate 4 is provided with cover-attachment-surfaces 4a on perimeter edges. Base-plate 4 side-wall edges are bent outward (flanged) to establish cover-attachment-surfaces 4a in horizontal planes with constant width.

(Base-Attachment-Surfaces 7a, 8a)

The cover-plate 5 is provided with base-attachment-surfaces that are bent outward (flanged) from the side-walls and mate with the cover-attachment-surfaces 4a. Since the cover-plate 5 in the example of FIGS. 4 and 7 is made up of a top cover 7 and an electrical component cover 8, the top cover 7 is provided with a base-attachment-surface 7a and the electrical component cover 8 is provided with a base-attachment-surface 8a. The cover-attachment-surfaces 4a and base-attachment-surfaces 7a, 8a connect via intervening sealing material 15 (described later) to achieve connecting regions that have a dust-free structure.

The base-plate 4 of the power source apparatus 100 shown in FIG. 7 has side-walls 4A that are approximately the same height on both sides. In the figure, the left side-wall 4A of the base-plate 4 is attached to the left side-wall 7A of the top cover 7. The right side-wall 4A of the base-plate 4 is not attached to a top cover 7 side-wall 7A, but rather is attached to the side-wall 8A of the electrical component cover 8, which is attached to the top cover 7. The top cover 7 is provided with side-walls 7A on both sides. In the figure, the top cover 7 side-wall 7A on the right side is taller than the side-wall 7A on the left side, the shorter side-wall 7A is attached to the base-plate 4 side-wall 4A on the left side, and the taller side-wall 7A on the right side is attached to the bottom of the base-plate 4.

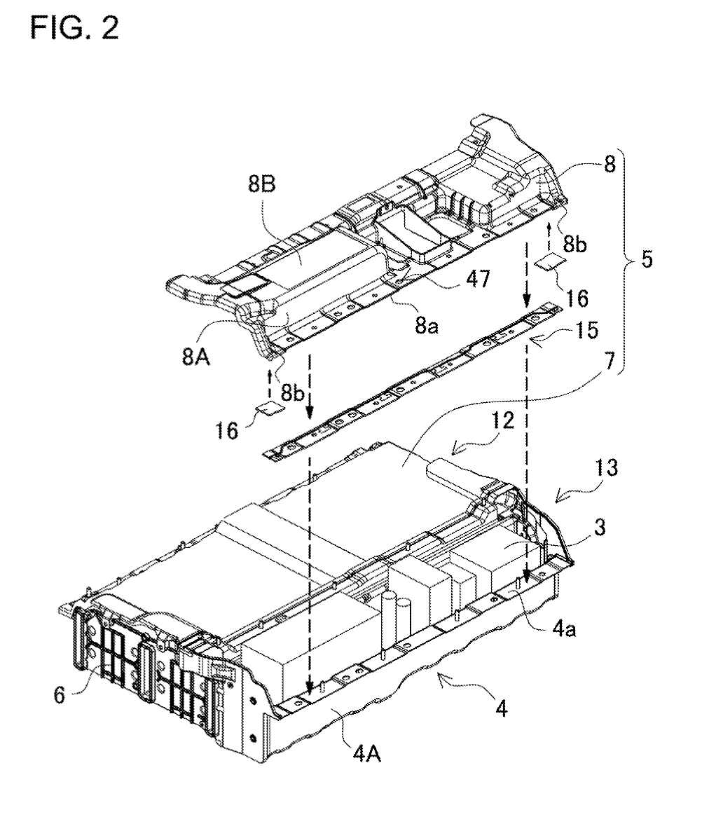

The electrical component cover 8 overlaps and is attached to upper surface of the top cover 7. As shown in figures such as FIG. 2, the electrical component cover 8 is metal formed in an L-shape with a top panel 8B and a side-wall 8A. The edge of the top panel 8B of the electrical component cover 8 is attached on top of the upper edge of the top cover 7, and the flanged base-attachment-surface 8a established at the bottom edge of the side-wall 8A is attached to the flanged cover-attachment-surface 4a on the upper edge of the side-wall 4A on the right side of the base-plate 4. In this outer case 10 configuration, the side-wall 7A on the right side of the top cover 7 separates the battery block 2 battery compartment 12 from the electrical component compartment 13.

### (Sealing Material 15)

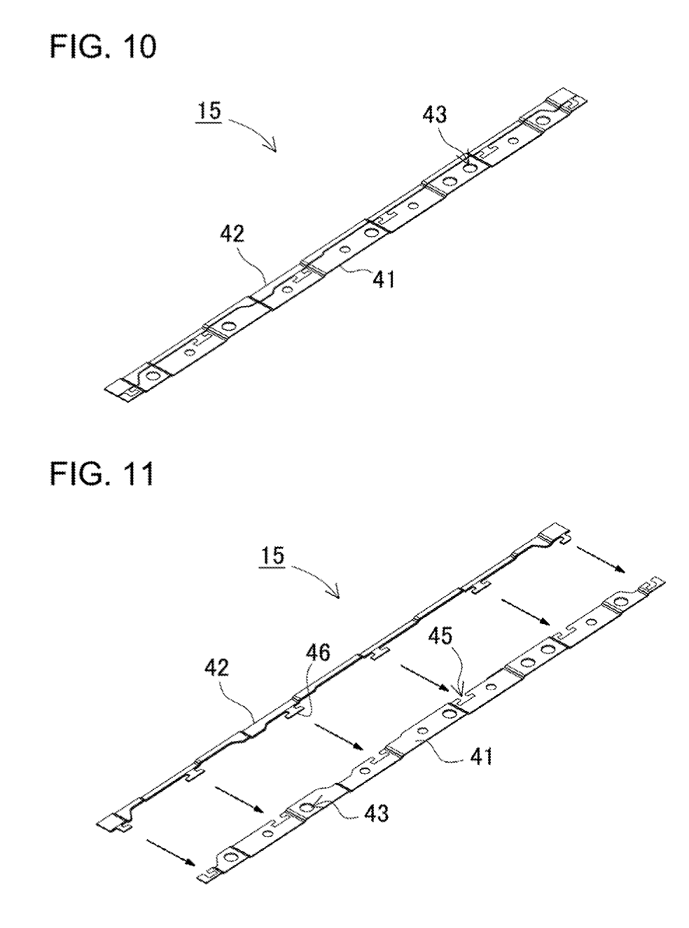

To achieve a dust-free structure between the side-plates 6 and the cover-plate 5, which is attached on top of the side-plates 6, intervening sealing material 15 is used. Sealing material 15 is attached to the upper surfaces of the side-plates 6 and sandwiched between the inside surfaces of the cover-plate 5 and the upper surfaces of the side-plates 6 to seal closed the connecting regions between the cover-plate 5 and the side-plates 6 for a dust-free structure. This type of sealing material 15 acts as gasket material. As shown in the oblique view of FIG. 10 and the exploded oblique view of FIG. 11, the sealing material 15 is made up of a flat-plate rigid piece 41 and a flexible piece 42 that connects on one side of the rigid piece 41. The flexible piece 42 achieves a structure that prevents ingress of dust, dirt, and moisture.

### (Rigid Piece 41)

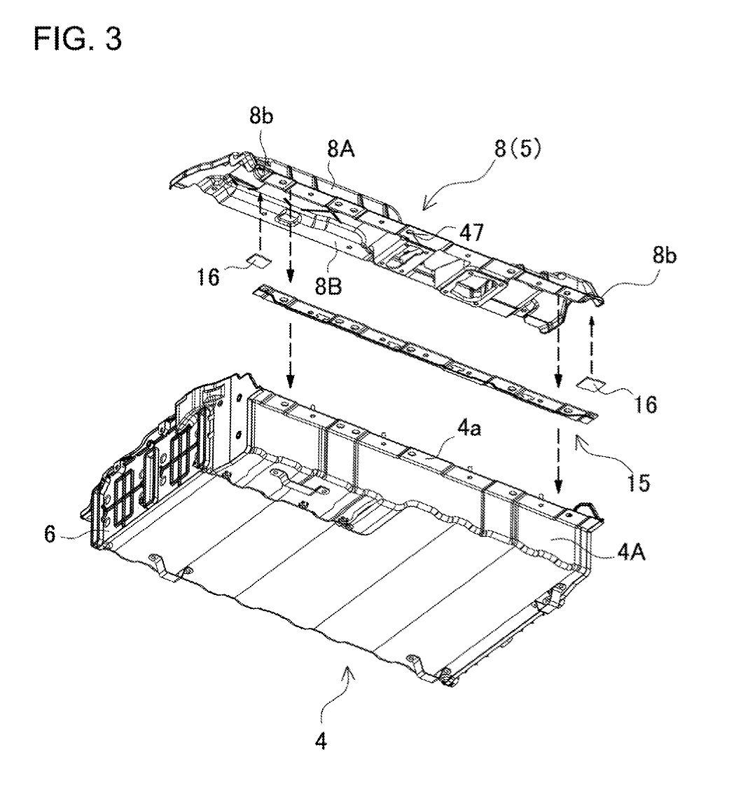

A sealing material 15 rigid piece 41 is made of essentially flat metal plate. However, as shown in FIGS. 2 and 3, when the base-attachment-surfaces 7a, 8a of the cover-plate 5 and the cover-attachment-surfaces 4a of the base-plate 4 have a stepped configuration, the rigid pieces 41 can be bent in a stepped configuration that conforms to the attachment-surface steps to intervene in a manner that minimizes gaps.

### (Through-Holes 43)

Through-holes 43 are opened through the rigid piece 41 for fastener insertion. The through-holes 43 are established in locations that correspond to fastening holes 47 opened through base-attachment-surfaces 7a, 8a for fastener insertion in connecting regions of the base-plate 4 and cover-plate 5. Fasteners are inserted through the fastening holes 47 and through-holes 43 and fastened together. Here, stud-bolts 27 and nuts 28 are used as the fasteners.

### (Fasteners)

Nuts and bolts can be appropriately used as the fasteners. However, rivets can also be used. In the example shown in the figures, stud-bolts 27, which are captive screws, are used. Here, stud-bolts 27 are inserted in the fastening holes 47 and base-plate 4 and cover-plate 5 connecting regions are solidly attached together by threading and tightening nuts 28 onto the stud-bolts 27. However, a configuration with threaded fastening holes can also be adopted instead of using nuts.

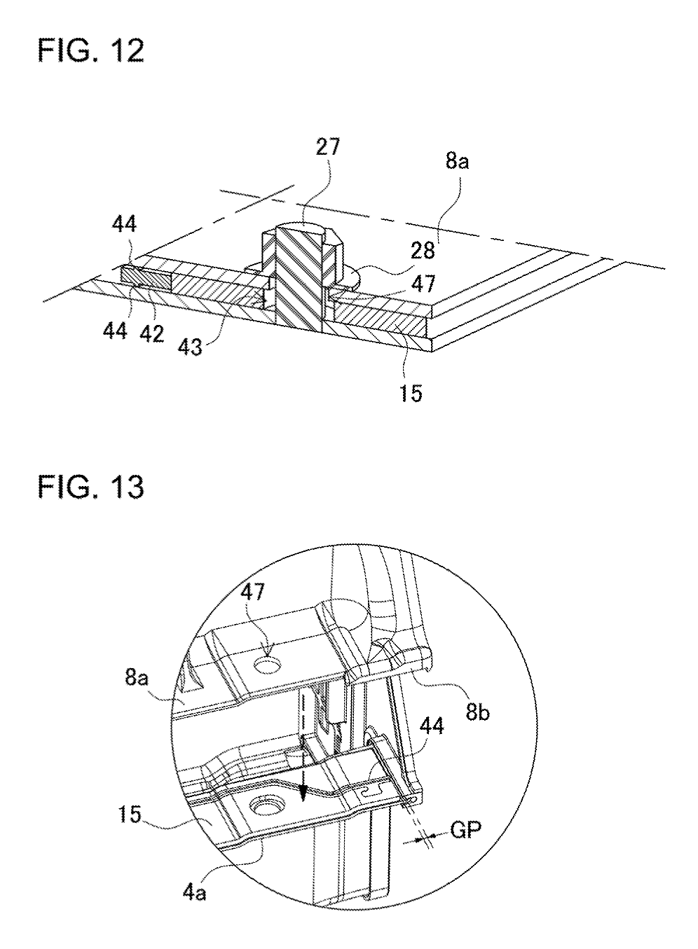

As shown in the cross-section view of FIG. 12, attachment stability is achieved by not disposing flexible pieces in the through-hole 43 regions. Accordingly, when the fasteners are tightened, flexible piece material is not sandwiched in between. This avoids detrimental conditions such as attachment loosening due to flexible piece degradation and flexible piece compression due to vibration.

Further, it is desirable to dispose flexible projections 44 (described later) established on the flexible pieces 42 in a location separated from the through-holes 43. By removing sealing structures such as the flexible projections 44 from the through-hole 43 regions, which are secured by fasteners, even external stress concentrated at the fasteners will not result in looseness. This can achieve stable, robust attachment and improve reliability. Further, considering manufacturing tolerances and bolt alignment, the circular through-holes and fastening holes can be made as extended circular holes that are longer in the lengthwise direction.

Further, the through-holes 43 are preferably disposed toward the outside of the connecting region sealed by the sealing material 15. This eliminates concerns related to moisture ingress via the through-holes 43.

### (Flexible Piece 42)

A flexible piece 42 is fitted along the lengthwise direction on one side of a rigid piece 41. The flexible piece 42 resiliently protrudes outward beyond the surfaces of the rigid piece 41 to seal the base-plate 4 to cover-plate 5 interface. To achieve this, the flexible piece 42 is provided with flexible projections 44 that protrude outward in directions approximately perpendicular to the interface between the base-plate 4 and the cover-plate 5. As shown in the oblique view of FIG. 10 and the exploded oblique view of FIG. 11, the flexible projections 44 extend along the lengthwise direction of the sealing material 15. In the example of FIGS. 10 and 11, the flexible projections 44 are established as ribs with hillock cross-sectional shapes that narrow at the top. A flexible piece 42 is formed as a single-piece structure from flexible material such as rubber.

The thickness of the flexible piece 42 is approximately the same as that of the rigid piece 41, or more desirably the flexible piece 42 is made slightly thicker than the rigid piece 41. As a result, cover-plate 5 to base-plate 4 attachment sandwiching flexible material in between can be established with the flexible piece 42 making direct contact with both metal plates. Consequently, attachment strength and reliability can be increased. In particular, the rigid piece 41 acts to increase the contacting surface area of the base-plate 4 and cover-plate 5. Accordingly, since the rigid piece 41 can make contact with the base-plate 4 and cover-plate 5 over a wide area, stress concentration due to vibration and impact can be avoided to maintain robustness with respect to vibration.

If the sealing material sandwiched between the base-plate 4 and cover-plate 5 is simply a gasket made of flexible material only, the thickness of the gasket, which is the interval between base-plate and cover-plate attachment-surfaces will change with stress application. Accordingly, gasket wear and damage are concerns particularly due to attachment-surface contact and friction generated by vibration at the interface. Further, gaskets made of rubber will degrade over time and their loss of resilience is also a concern. In contrast, by sandwiching flat metal plate material between the metal attachment-surfaces, the metal base-plate and metal cover-plate can be attached in a stable manner to minimize changes in the size of the interval between attachment-surfaces, minimize looseness, achieve stable attachment, and maintain capability to prevent dust, dirt, and water ingress.

### (Interlock Tabs 46)

The rigid pieces 41 and flexible pieces 42 described above are connected together via an interlocking structure. In the example of FIG. 11, the flexible piece 42 is provided with interlock tabs 46 extending in a planar direction, and the rigid piece 41 has interlock cut-outs 45 formed in shapes that accept interlock tab 46 insertion. Sealing material 15 is assembled by inserting the interlock tabs 46 in the interlock cut-outs 45. In the example of FIG. 11, flexible piece 42 interlock tabs 46 are formed in a T-shape and extend in a direction perpendicular to the direction of protrusion of the flexible projections 44. Namely, the interlock tabs 46 extend in a direction within the plane of the sealing material 15. Further, the interlock cut-outs 45 are formed in the rigid piece 41 as T-shaped cut-outs that can accept interlock tab 46 insertion. In this manner, the flexible piece 42 can be joined to the rigid piece 41 by fitting flexible piece 42 interlock tabs 46 into rigid piece 41 interlock cut-outs 45. The interlock tabs 46 are formed in single-piece construction with the flexible piece 42. By forming the interlock cut-outs 45 slightly smaller than the interlock tabs 46, insertion of flexible piece 42 interlock tabs 46 in the interlock cut-outs 45 resiliently distorts the interlock tabs 46 and joins the flexible piece 42 and rigid piece 41 without forming gaps. Further, the T-shaped interlock tabs 46 and interlock cut-outs 45 prevent the interlocked sealing material 15 from pulling apart laterally and achieve alignment of the flexible piece 42 with the rigid piece 41. In particular, when sealing material is sandwiched between the base-plate 4 and cover-plate 5, proper alignment of the interlock tabs 46 in the interlock cut-outs 45 can avoid sandwiching the flexible piece in an unintended disposition. For example, in a different structure with attachment-surfaces designed for flexible gasket alignment, there is no way to determine gasket misalignment after closing the attachment-surfaces even if the flexible gasket is closed inside the connecting region in a chaotic manner. In contrast, the sealing material 15 described above with a flexible piece 42 and rigid piece 41 joined together allows visual confirmation of sealing material 15 position during attachment of the base-plate 4 and cover-plate 5. Further, since flexible piece 42 misalignment results in rigid piece 41 misalignment, even if the attachment-surfaces are closed with sealing material 15 in an unintended disposition, that flaw can be detected. This improves the reliability of cover-plate 5 to base-plate 4 attachment. Note the interlock tabs can also have a shape other than a T-shape such as an L-shape or +-shape.

With this type of sealing material 15 made up of a rigid piece 41 and a flexible piece 42, the ability to prevent dust and dirt ingress can be maintained over a long period. Long term maintenance of a dust-free structure has been an obstacle for prior art rubber gaskets particularly in environments subject to vibration and impact as in automotive power source apparatus. When a rubber gasket degrades, its resilience weakens and it looses sealing capability. In contrast, in the assembly described above, which combines a metal plate rigid piece and a flexible piece, the load on the flexible piece is reduced even with severe impact forces. Consequently, this sealing material assembly can achieve a dust-free structure that can endure vibration and increase reliability.

(Hood Segments 8b)

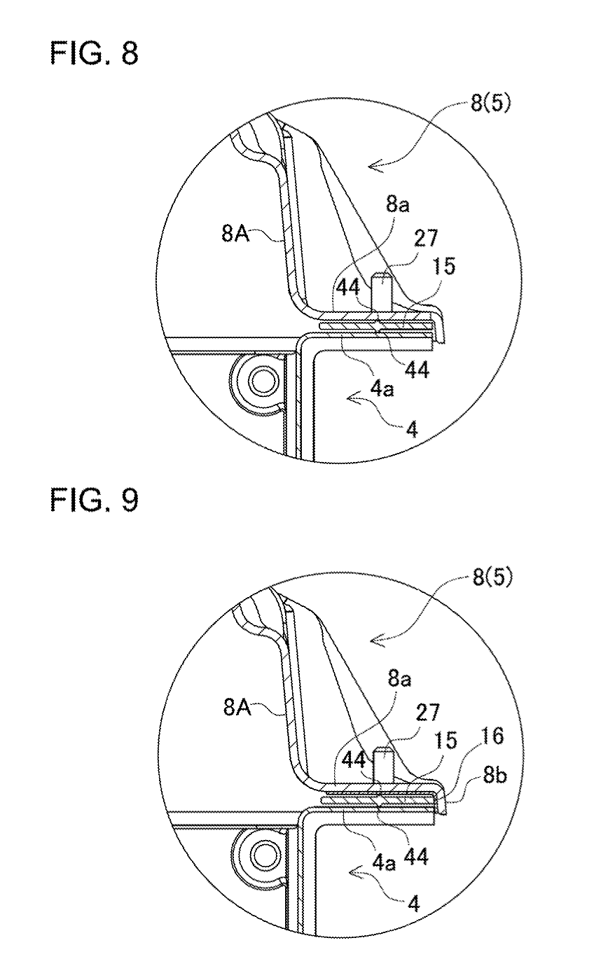

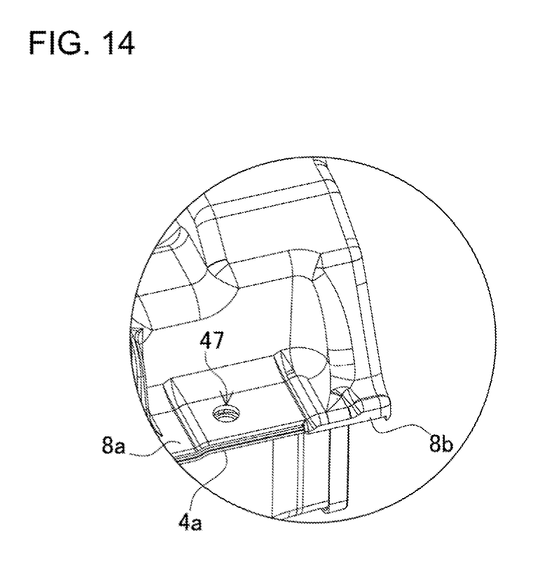

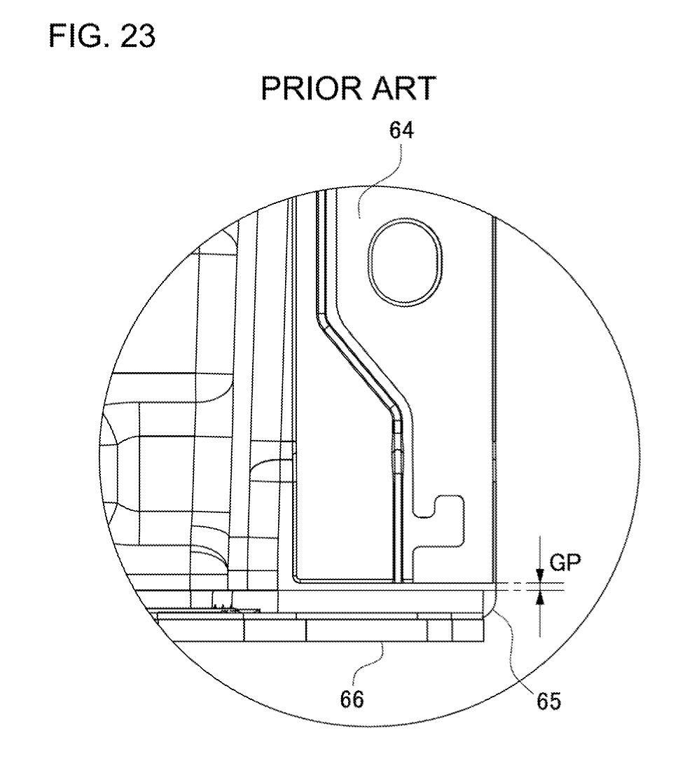

As shown in FIG. 8 and as described above, sandwiching sealing material 15 in connecting regions between the base-plate 4 and cover-plate 5 can achieve a dust-free structure along the lengthwise direction of the sealing material 15. However, this type of protection against dust and dirt cannot be obtained in regions where the sealing material cannot be disposed. For example, in a connecting region corner at a side-plate as shown in FIG. 23, manufacturing tolerance considerations make it extremely difficult to form the end of the sealing material in a manner that makes complete connection with the side-plate, and a gap GP results. The gap in a location like this cannot be closed-off with sealing material alone. Accordingly, as shown in the cross-section view of FIG. 9, the exploded oblique view of FIG. 13, and the oblique view of FIG. 14, downward bending hood segments 8b are provided in the cover-plate 5 base-attachment-surface 8a, and sealing pieces 16 are provided that extend along the inside surfaces of the cover-plate 5 from the base-attachment-surface 8a to the hood segments 8b to cover the connecting regions from the outside. As a result, the hood segments 8b cover the sides of the sealing material 15 and the cover-attachment-surface 4a from a direction that is approximately perpendicular to the connecting region interface. Further, as shown in FIGS. 13 and 14, the hood segments 8b extend in the lengthwise direction of the base-plate 4 to cover the interface between the base-plate 4 and the side-plates 6. This adds a structure that applies pressure to the connecting region from a horizontal direction instead of from a vertical direction, and enables the gap region to be sealed-closed by extending over, and covering that region.

### (Sealing Pieces 16)

The sealing pieces 16 can be formed from flexible material with superior resilience such as urethane. The sealing pieces 16 do not need to be established over the entire length of the cover-plate 5 base-attachment-surface 8a, but rather are made to a length that can at least cover each gap region. In the lateral direction as shown in FIG. 9, sealing pieces 16 are made at least wide enough to stack on top of the sealing material 15 flexible projections 44. This reliably covers the gaps that cannot be sealed-off with the sealing material 15 flexible projections 44, and forms a continuous sealing unit with the flexible projections 44 for a dust-free structure.

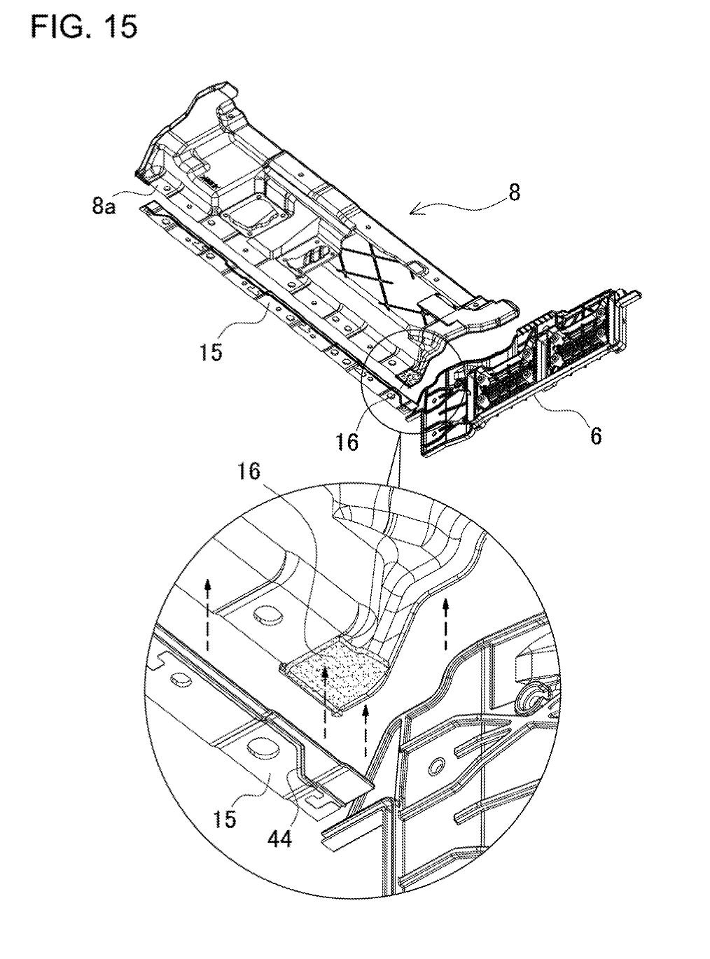

Further as shown in FIG. 15, it is desirable to adhesively pre-attach the sealing pieces 16 to the backsides of the hood segments 8b. This makes sealing piece 16 alignment unnecessary and improves the efficiency of assembly operations. However, a configuration is also possible where the sealing pieces are adhesively attached to the sealing material side rather than the cover-plate side.

Although the example above describes a dust-free structure with hood segments 8b established on the cover-plate side, the dust-free structure is not limited to that configuration. For example; a similar dust-free structure can be implemented with hood segments established on the base-plate side. In this case however, the base-plate cover-attachment-surface is bent upward to form the hood segments. Consequently, the hood segments are formed in a manner that opens upward, and this structure has the problem that dust and dirt can easily fall into and collect in the hood segments. Accordingly, previously described hood segments that bend downward from the cover-plate base-attachment-surface open downward, do not have this dust-collecting problem, and are preferable.

### Second Embodiment

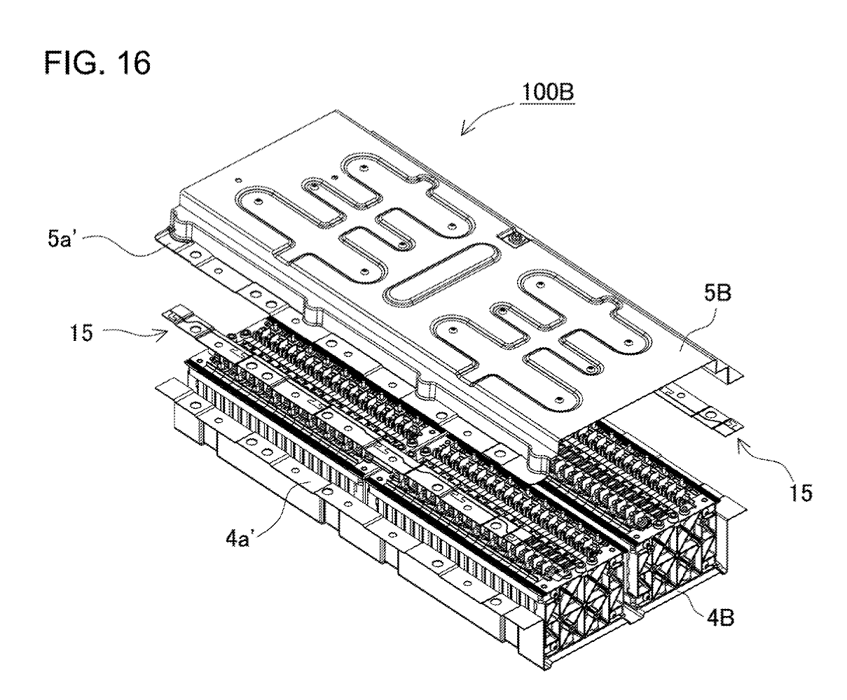

In the previously described example, not considering the side-plates, the case was described as a three piece structure with a base-plate and a cover-plate made up of two parts. However, the present invention is not limited to that structure. For example, a case having a two piece structure with an upper and lower case can also be adopted. This type of structure is shown in FIG. 16 as the second embodiment. The case of the power source apparatus 100B shown in this figure is made up of a base-plate 4B with an open top, and a cover-plate 5B that closes-off the open region of the base-plate 4B. The cover-plate 5B seals the open region closed with intervening sealing material 15 in a manner that prevents dust and dirt ingress and is attached with fasteners. The base-plate 4B has the shape of a box with an open top and houses battery blocks 2 and electrical components, etc. inside. The base-plate 48 has cover-attachment-surfaces 4a′ established along its perimeter and cover-plate 5B base-attachment-surfaces 5a′ are attached to the cover-attachment-surfaces 4a′ sandwiching sealing material 15 in between to establish a dust-free structure.

The power source apparatus described above can be used as a power source on-board a vehicle. An electric powered vehicle such as a hybrid vehicle driven by both an engine and an electric motor, a plug-in hybrid vehicle, or an electric vehicle driven by an electric motor only can be equipped with the power source apparatus and use it as an on-board power source.

### (Power Source Apparatus in a Hybrid Vehicle Application)

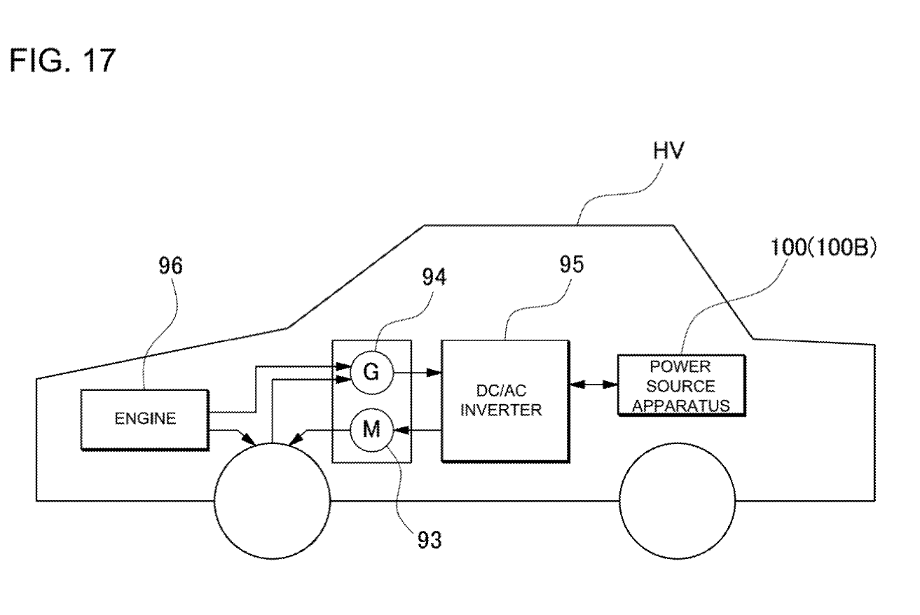

FIG. 17 shows an example of power source apparatus installation on-board a hybrid vehicle, which is driven by both an engine and an electric motor. The vehicle HV equipped with the power source apparatus shown in this figure is provided with an engine 96 and a driving motor 93 to drive the vehicle HV, a power source apparatus 100, 100B to supply power to the motor 93, and a generator 94 to charge the power source apparatus 100, 100B batteries. The power source apparatus 100, 100B is connected to the motor 93 and generator 94 via a DC/AC inverter 95. The vehicle HV runs on both the motor 93 and engine 96 while charging the batteries in the power source apparatus 100, 100B. In operating modes where engine efficiency is poor such as during acceleration and low speed cruise, the vehicle is driven by the motor 93. The motor 93 operates on power supplied from the power source apparatus 100, 100B. The generator 94 is driven by the engine 96 or by regenerative braking when the vehicle brake pedal is pressed and operates to charge the power source apparatus 100, 100B batteries.

### (Power Source Apparatus in an Electric Vehicle Application)

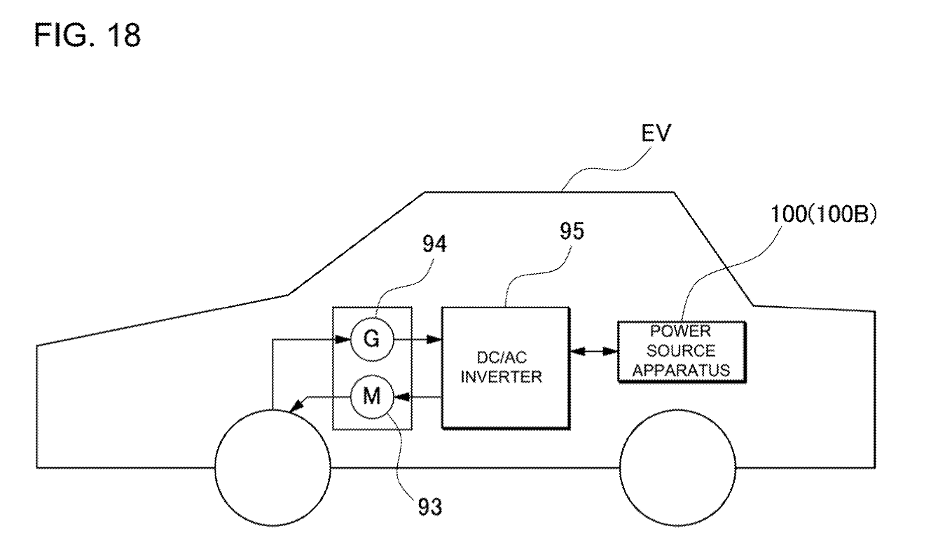

FIG. 18 shows an example of power source apparatus installation on-board an electric vehicle, which is driven by an electric motor only. The vehicle EV equipped with the power source apparatus shown in this figure is provided with a driving motor 93 to drive the vehicle EV, a power source apparatus 100, 100B to supply power to the motor 93, and a generator 94 to charge the power source apparatus 100, 100B batteries. The power source apparatus 100, 100B is connected to the motor 93 and generator 94 via a DC/AC inverter 95. The motor 93 operates on power supplied from the power source apparatus 100, 100B. The generator 94 is driven by energy from regenerative braking and operates to charge the power source apparatus 100, 100B batteries.

### (Power Source Apparatus in a Power Storage Application)

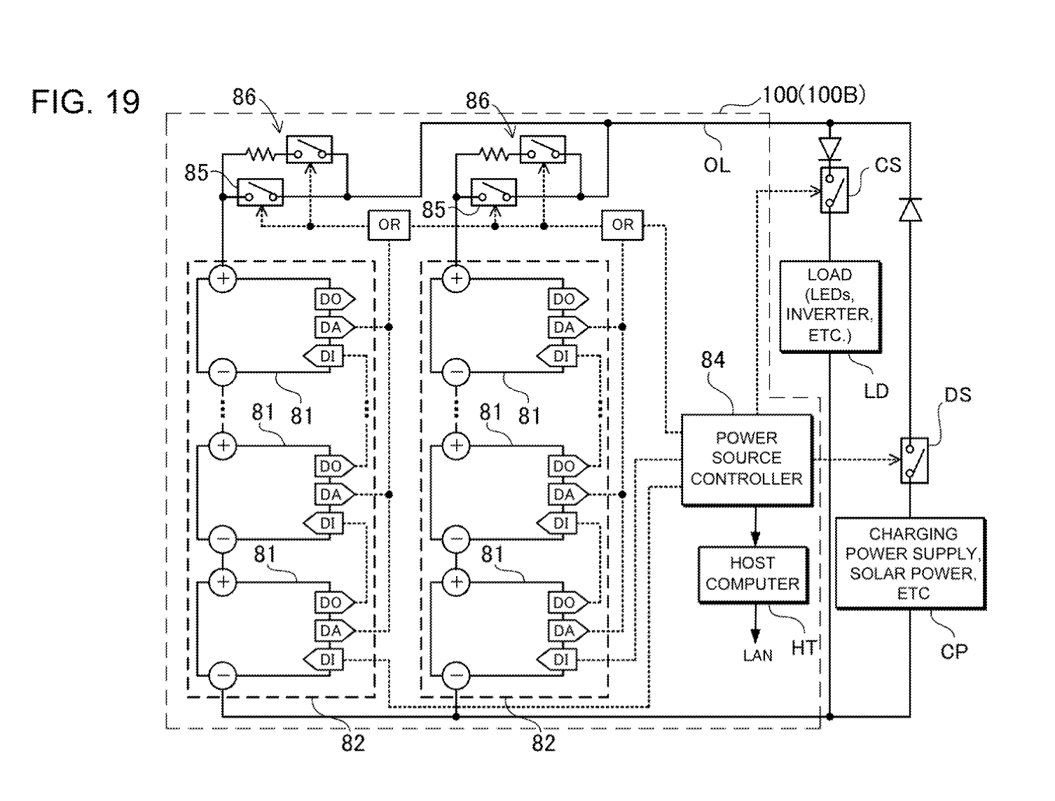

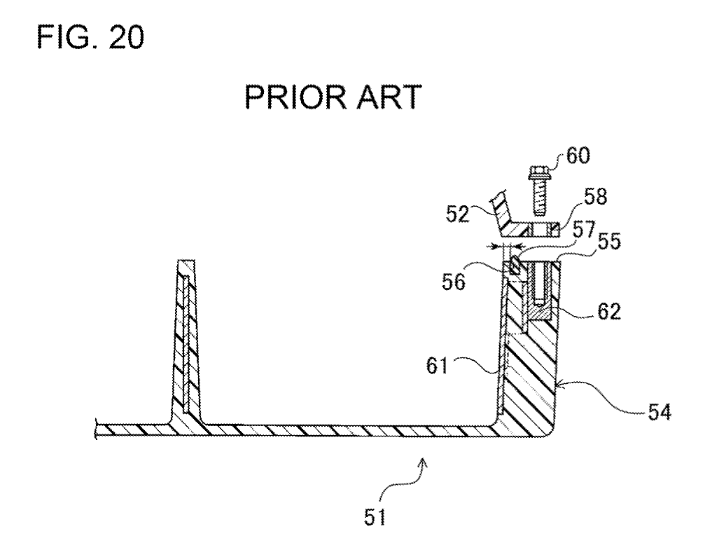

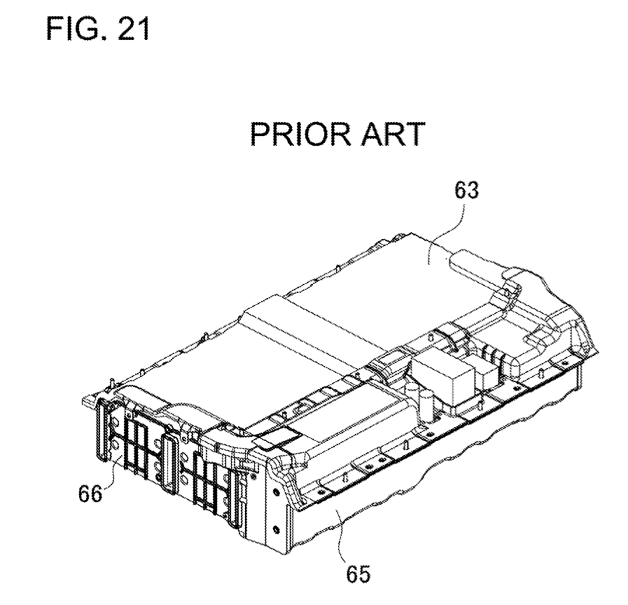

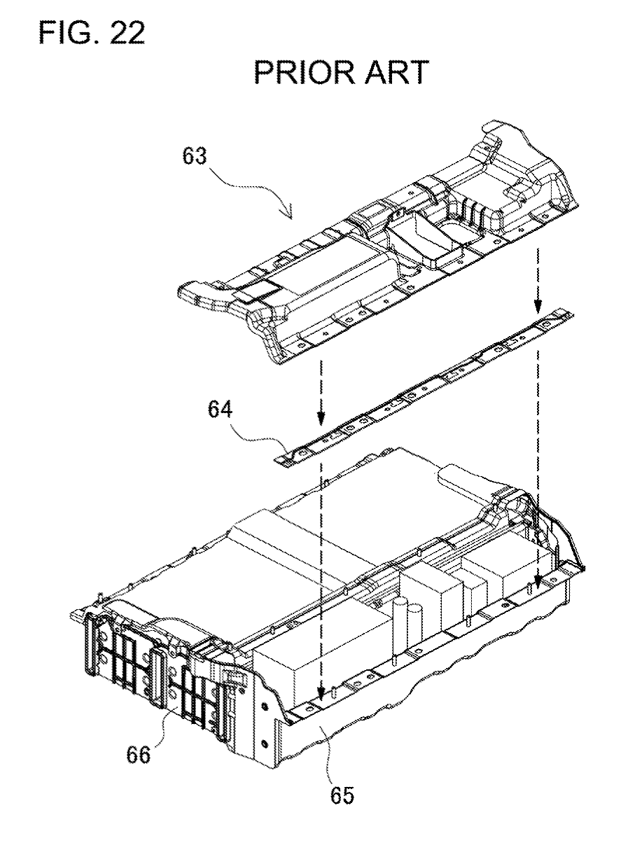

The power source apparatus can be used not only as the power source in motor vehicle applications, but also as an on-board (mobile) power storage resource. For example, it can be used as a power source system in the home or manufacturing facility that is charged by solar power or late-night (reduced-rate) power and discharged as required. It can also be used for applications such as a streetlight power source that is charged during the day by solar power and discharged at night, or as a backup power source to operate traffic signals during power outage. An example of a power source apparatus for these types of applications is shown in FIG. 19. The power source apparatus 100, 100B shown in this figure has a plurality of battery packs 81 connected to form battery units 82. Each battery pack 81 has a plurality of battery cells connected in series and/or parallel. Each battery pack 81 is controlled by a power source controller 84. After charging the battery units 82 with a charging power supply CP, the power source apparatus 100, 100B drives a load LD. Accordingly, the power source apparatus 100, 100B has a charging mode and a discharging mode. The load LD and the charging power supply CP are connected to the power source apparatus 100, 100B through a discharge switch DS and a charging switch CS respectively. The discharge switch DS and the charging switch CS are controlled ON and OFF by the power source apparatus 100, 100B power source controller 84. In the charging mode, the power source controller 84 switches the charging switch CS ON and the discharge switch DS OFF to allow the power source apparatus 100, 100B to be charged from the charging power supply CP. When charging is completed by fully-charging the batteries or by charging to a battery capacity at or above a given capacity, the power source apparatus can be switched to the discharging mode depending on demand by the load LD. In the discharging mode, the power source controller 84 switches the charging switch CS OFF and the discharge switch DS ON to allow discharge from the power source apparatus 100, 1008 to the load LD. Further, depending on requirements, both the charging switch CS and the discharge switch DS can be turned ON to allow power to be simultaneously supplied to the load LD while charging the power source apparatus 100, 1008.

The load LD driven by the power source apparatus 100, 1008 is connected through the discharge switch DS. In the discharging mode, the power source controller 84 switches the discharge switch DS ON to connect and drive the load LD with power from the power source apparatus 100, 1008. A switching device such as a field effect transistor (FET) can be used as the discharge switch DS. The discharge switch DS is controlled ON and OFF by the power source apparatus 100, 100B power source controller 84. In addition, the power source controller 84 is provided with a communication interface to communicate with externally connected equipment. In the example of FIG. 19, the power source controller 84 is connected to an external host computer HT and communicates via known protocols such as universal asynchronous receiver transmitter (UART) and recommended standard-232 (RS-232C) protocols. Further, depending on requirements, a user interface can also be provided to allow direct user operation.

This power source apparatus 100, 100B also has an equalization mode to equalize the battery units 82. Battery units 82 are connected in parallel through parallel connection switches 85 that connect the battery units 82 to an output line OL. Accordingly, equalization circuits 86 are provided that are controlled by the power source controller 84. Remaining battery capacity variation among the plurality of battery units 82 can be suppressed by operating the equalization circuits 86

### INDUSTRIAL APPLICABILITY

The power source apparatus, dust-free case, and vehicle equipped with the power source apparatus of the present invention can be appropriately used as a power source apparatus in a vehicle such as a plug-in hybrid electric vehicle that can switch between an electric vehicle mode and a hybrid vehicle mode, a hybrid electric vehicle, and an electric vehicle. The present invention can also be appropriately used in applications such as a server computer backup power source that can be rack-installed, a backup power source apparatus for a wireless base station such as a cell-phone base station, a power storage apparatus for the home or manufacturing facility, a streetlight power source, a power storage apparatus for use with solar cells, and a backup power source in systems such as traffic signals. Further, the dust-free case is not limited to housing only a power source apparatus, but can also be used appropriately in other applications that require a dust-free structure.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2010-291365 filed in Japan on Dec. 27, 2010, the content of which is incorporated herein by reference.

What is claimed is:

1. A power source apparatus comprising:
battery blocks having a plurality of battery cells connected together;
a base-plate that holds the battery blocks and has cover-attachment-surfaces established on perimeter edges;
a cover-plate that closes-off the top of the base-plate and has base-attachment-surfaces established on perimeter edges that join with base-plate cover-attachment-surfaces; and
sealing material that intervenes between base-plate cover-attachment-surfaces and cover-plate base-attachment-surfaces and has flexible projections extending in the lengthwise direction,
wherein ends of the cover-plate are provided with hood segments that extend from the base-attachment-surfaces in a direction approximately perpendicular to the attachment-surfaces and cover the sides of the sealing material and cover-attachment-surfaces,
wherein sealing pieces are provided between the cover-plate and the sealing material in a manner that extends continuously from the base-attachment-surface to the hood segment, and
wherein with sealing material intervening between cover-attachment-surfaces and base-attachment-surfaces, base-plate and cover-plate attachment-surfaces are sealed together with the sealing pieces compressed on top of the flexible projections.

2. The power source apparatus as cited in claim 1 wherein side-plates are provided that close-off open ends of the cover-plate and base-plate,
wherein gaps are formed at the boundaries between the side-plates and the ends of the attachment-surfaces, and
wherein the hood segments and sealing pieces are established in the gap regions.

3. The power source apparatus as cited in claim 2 wherein the hood segments extend in the lengthwise direction of the base-plate to cover boundaries between the base-plate and side-plates.

4. The power source apparatus as cited in claim 1 wherein the sealing pieces are adhesively attached to the undersides of the cover-plate.

5. The power source apparatus as cited in claim 1 wherein the sealing material is configured as a flat-plate rigid piece and a flat-plate flexible piece that interlocks with the rigid piece.

6. The power source apparatus as cited in claim 5 wherein the boundary between the rigid piece and the flexible piece can be formed with segments that are not in a straight-line, and the flexible projections can be established on the flexible piece following the meandering boundary.

7. A vehicle equipped with the power source apparatus as cited in claim 1.

8. A dust-free case comprising:
a base-plate that holds the battery blocks and has cover-attachment-surfaces established on perimeter edges;
a cover-plate that closes-off the top of the base-plate and has base-attachment-surfaces established on perimeter edges that join with base-plate cover-attachment-surfaces; and
sealing material that intervenes between base-plate cover-attachment-surfaces and cover-plate base-attachment-surfaces and has flexible projections extending in the lengthwise direction,
wherein ends of the cover-plate are provided with hood segments that extend from the base-attachment-surfaces in a direction approximately perpendicular to the attachment-surfaces and cover the sides of the sealing material and cover-attachment-surfaces,
wherein sealing pieces are provided between the cover-plate and the sealing material in a manner that extends continuously from the base-attachment-surface to the hood segment, and
wherein with sealing material intervening between cover-attachment-surfaces and base-attachment-surface, base-plate and cover-plate attachment-surfaces are sealed together with the sealing pieces compressed on top of the flexible projections.
